(19) United States
(12) Patent Application Publication
(10) Pub. No.: US 2019/0010634 A1
(43) Pub. Date: Jan. 10, 2019

(54) ANISOTROPIC TATAMI COVER

(71) Applicant: SEKISUI SEIKEI CO., LTD., Osaka-shi, Osaka (JP)

(72) Inventors: Hiroshi AOTANI, Osaka-shi, Osaka (JP); Yuuji YOKOTA, Osaka-shi, Osaka (JP); Hayato SHIMADA, Osaka-shi, Osaka (JP); Akira INATSU, Osaka-shi, Osaka (JP); Satoru UEINUI, Osaka-shi, Osaka (JP)

(21) Appl. No.: 16/081,795

(22) PCT Filed: Dec. 26, 2016
(86) PCT No.: PCT/JP2016/088802

§ 371 Date: Aug. 31, 2018

(30) Foreign Application Priority Data
Mar. 1, 2016 (JP) 2016-039268

(51) Int. Cl. D03D 15/00; D03D 1/00; D02G 3/06; B32B 5/02; B32B 7/12; B32B 27/32; B32B 27/12; D02G 3/44; E04F 15/16

(52) U.S. Cl. CPC D03D 15/0033; B32B 2262/0276; D02G 3/06; B32B 5/024; B32B 7/12; B32B 27/32; B32B 27/12; D02G 3/445; E04F 15/163; D03D 2700/0174; D10B 2321/022; D10B 2331/04; D03D 2700/0133; D10B 2503/04; B32B 2471/00; B32B 2307/404; D03D 1/0017

(57) ABSTRACT

An anisotropic tatami cover can provide different hues depending on the angle from which it is viewed, and is therefore highly aesthetically valuable. The anisotropic tatami cover is made of weft yarns made of rush grass or artificial rush grass and warp yarns, is woven in such a manner that the warp yarns are exposed on the surface, and has a color difference ΔE of 6.0 or more between the weft and warp yarns.

### TECHNICAL FIELD

The present invention relates to an anisotropic tatami cover that can provide different hues depending on the angle from which it is viewed, and is therefore highly aesthetically valuable.

### BACKGROUND ART

A tatami mat is widely used as a flooring material in Japanese-style houses and is constituted by a tatami cover (tatami omote) layered on the surface of a tatami base (tatami doko). Tatami covers are generally woven in a “hikime” weave pattern. The “hikime” weave pattern is, as shown in FIG. 8, a weave pattern in which a set of two weft yarns (rush grass (igusa)) (200, 200) is interlaced with a set of two warp yarns (300, 300) one-by-one (see, e.g., Patent Literature 1 and 2). The “hikime” weave pattern has various types such as a “morome” weave pattern, a “meseki” weave pattern and an “oome” weave pattern, which differ in the number of warp yarns.

In such tatami covers, warp yarns are enclosed by weft yarns (rush grass) which are in close contact with each other. Due to this constitution, the warp yarns are not visible on the surface of the tatami covers. If warp yarns are visible, such tatami covers are defective products due to lack of enough strength. Stated in another way, only the weft yarns (rush grass) are exposed on the surface. Therefore, from whatever angle the tatami covers are viewed, the hue is constant and invariable, and such tatami covers are not much aesthetically valuable.

### CITATION LIST

### Patent Literature

Patent Literature 1: JP H10-183957A
Patent Literature 2: JP 2002-188276A

### SUMMARY OF INVENTION

### Technical Problem

The present invention has been made in view of the above-mentioned problem, and an object of the present invention is to provide an anisotropic tatami cover that can provide different hues depending on the angle from which it is viewed, and is therefore highly aesthetically valuable.

### Solution to Problem

That is, the present invention relates to the following.
[1] An anisotropic tatami cover, which is made of weft yarns made of rush grass or artificial rush grass and warp yarns, and which is woven in such a manner that the warp yarns are exposed on the surface, wherein a color difference ΔE between the weft and warp yarns is 6.0 or more.
[2] The anisotropic tatami cover according to the said [1], wherein the weft yarns have a diameter of 0.5 to 2 mm and the warp yarns have a diameter which is 5 to 80% of the diameter of the weft yarns.
[3] The anisotropic tatami cover according to the said [1] or [2], wherein the weft yarns are of one or more colors.
[4] The anisotropic tatami cover according to any one of the said [1] to [3], wherein the warp yarns are hemp yarns, cotton yarns, polyester yarns or yarns made of a mixture of cotton and polyester.
[5] The anisotropic tatami cover according to any one of the said [1] to [4], wherein the warp yarns are of one or more colors.
[6] The anisotropic tatami cover according to any one of the said [1] to [5], wherein the anisotropic tatami cover is woven in a plain or twill weave pattern.
[7] The anisotropic tatami cover according to any one of the said [1] to [6], wherein the weft yarns adjacently arranged are in close contact with each other and the warp yarns adjacent to each other are arranged at an interval of 5 to 30 mm.
[8] The anisotropic tatami cover according to any one of the said [1] to [7], wherein the anisotropic tatami cover further has a backing sheet bonded to the underside of the anisotropic tatami cover.

### Advantageous Effects of Invention

The constitution of the anisotropic tatami cover of the present invention is as described above. Due to the constitution, the anisotropic tatami cover can provide different hues depending on the angle from which it is viewed, and is therefore highly aesthetically valuable. When a tatami mat using this tatami cover as a top layer is laid in a room or the like, the tatami mat provides different hues depending on the angle from which it is viewed in the room or the like, and thus makes the room or the like more decorative.

### BRIEF DESCRIPTION OF DRAWINGS

FIG. 1 is a plan view of an example of the anisotropic tatami cover of the present invention.

FIG. 2 is an A-A sectional view of FIG. 1.

FIG. 3 is a plan-view photograph of the anisotropic tatami cover of Example 1.

FIG. 4 is a photograph of the anisotropic tatami cover of Example 1 viewed from the height at an angle of 30 degrees above horizontal along the direction parallel to the warp yarns.

FIG. 5 is a photograph of the anisotropic tatami cover of Example 1 viewed from the height at an angle of 30 degrees above horizontal along the direction parallel to the weft yarns.

FIG. 6 is a cross-sectional view of an example of a thick tatami mat.

FIG. 7 is a cross-sectional view of an example of a thin tatami mat.

FIG. 8 is a cross-sectional view of an example of a conventional tatami cover.

### DESCRIPTION OF EMBODIMENTS

The anisotropic tatami cover of the present invention is made of weft yarns made of rush grass or artificial rush grass and warp yarns, is woven in such a manner that the warp yarns are exposed on the surface, and has a color difference ΔE of 6.0 or more between the weft and warp yarns.

The weft yarns used in the present invention are made of rush grass or artificial rush grass. The artificial rush grass is, for example, made from a synthetic resin such as an olefin-type resin or from twisted paper. Any type of conventionally known artificial rush grass may be used.

The artificial rush grass can be made, for example, in the following manner. A resin film made from an olefin-type resin, an inorganic filler, a colorant, etc. is uniaxially stretched and then made into tape-like strands. The tape-like strands are bundled together like a single string. The string-like bundle of the tape-like strands is passed through a narrow hole of a heating member so that the tape-like strands are randomly fusion bonded to each other to forma single straw of artificial rush grass, and at the same time, fusion coating is formed on the surface of the artificial rush grass straw.

Examples of the olefin-type resin include a high-density polyethylene resin, a medium-density polyethylene resin, a low-density polyethylene resin, a linear low-density polyethylene resin, a polypropylene resin, an ethylene-propylene copolymer, an ethylene-1-butene copolymer, an ethylene-1-pentene copolymer, an ethylene-1-hexene copolymer, and the like.

Examples of the inorganic filler include calcium carbonate, magnesium carbonate, aluminum oxide, magnesium oxide, titanium oxide, magnesium hydroxide, talc, mica, clay, and the like.

In the case where the resin film containing an inorganic filler is uniaxially stretched and made into tape-like strands, the inorganic filler serves as a core for pore formation in the tape-like strands, thus enhancing lightweight, heat-insulating, cushioning and other properties. For these reasons, the inorganic filler content is preferably 10 to 50 parts by weight relative to 100 parts by weight of the olefin-type resin.

Examples of the colorant include organic pigments such as azo-type pigments, phthalocyanine-type pigments, threne-type pigments, lake pigments, and the like; and inorganic pigments such as oxide-type pigments, chromate-molybdate-type pigments, sulfide-selenide-type pigments, ferrocyanide-type pigments, and the like. The colorant content can be selected as appropriate. Generally, the colorant content is preferably 0.1 to 10 parts by weight, and more preferably 1 to 5 parts by weight relative to 100 parts by weight of the olefin-type resin.

Further, antioxidants such as phenolic-type antioxidants, aromatic amine-type antioxidants, and the like; ultraviolet absorbers based on salicylates, benzophenones, benzotriazoles, cyanoacrylates, and the like; light stabilizers based on hindered amines; antistatic agents such as cationic-type antistatic agents, nonionic-type antistatic agents, and the like; impact modifiers; anti-fog agents; flame retardants; and other additives may be used as an additional component as appropriate.

The resin film made from an olefin-type resin, an inorganic filler, a colorant, etc. can be produced by a conventionally known film-forming method such as an extrusion method, a T-die method, a casting method, a calendering method, an inflation method, a pressing method, and the like.

The tape-like strands are made by uniaxial stretching of the resin film. The method for uniaxial stretching may be selected from conventionally known methods, and is, for example, uniaxial roll stretching, uniaxial zone stretching, or the like.

In the case where the temperature in uniaxial stretching is excessively low, uniform stretching is not achieved, and in the case where the temperature is excessively high, the resin film becomes melt and broken. For these reasons, the temperature in uniaxial stretching is preferably in the range of “a 60° C. lower temperature than the melting point of the olefin-type resin in the resin film” to “the melting point of the olefin-type resin”, and more preferably in the range of “a 50° C. lower temperature than the melting point of the olefin-type resin” to “a 5° C. lower temperature than the melting point of the olefin-type resin”.

As the stretching ratio in uniaxial stretching decreases, mechanical strength declines, and as the stretching ratio increases, stiffness increases, thereby impairing the distinctive texture of tatami covers. For these reasons, the stretching ratio is preferably 2 to 10. The thickness of the tape-like strands is preferably 5 to 20 μm.

The said tape-like strands are bundled together like a single string. The string-like bundle of the tape-like strands is passed through the narrow hole of the heating member so that the tape-like strands are randomly fusion bonded to each other to forma single straw of artificial rush grass, and at the same time, fusion coating is formed on the surface of the artificial rush grass straw. In this process, preferably, the string-like bundle of the tape-like strands is formed by folding tape-like strands along the uniaxial stretching direction into a packed form; by twisting narrow tape-like strands; by braiding narrow tape-like strands; or by other methods. The said string-like bundle of the tape-like strands is passed through the hole of the heating member.

The heating member is not limited as long as it is heatable and has a narrow hole that the string-like bundle can pass through, but it is preferable that the diameter of the hole is 50 to 90% of the diameter of the string-like bundle in order to appropriately perform the process in which the string-like bundle of the tape-like strands is passed through the narrow hole of the heating member so that the tape-like strands are randomly fusion bonded to each other to form a single straw of artificial rush grass, and at the same time, fusion coating is formed on the surface of the artificial rush grass straw. The cross-sectional shape of the hole is approximately the same as that of the desired artificial rush grass. For example, the cross-sectional shape is preferably a circle, an ellipse, or the like. On the surface of the exit end of the hole, projections may be provided for the formation of corrugations and/or pores on the fusion coating.

The heating temperature of the heating member is selected as appropriate for performing the process in which the string-like bundle of the tape-like strands is passed through the narrow hole of the heating member so that the tape-like strands are randomly fusion bonded to each other to forma single straw of artificial rush grass, and at the same time, fusion coating is formed on the surface of the artificial rush grass straw. Accordingly, the heating temperature is equal to or higher than the melting point of the olefin-type resin contained in the tape-like strands, and is preferably in the range of “a 100° C. higher temperature than the melting point of the olefin-type resin” to “a 150° C. higher temperature than the melting point of the olefin-type resin”.

As the speed of the string-like bundle passing through the hole of the heating member decreases, the degree of fusion bonding of the tape-like strands increases, thus providing a less porous, heavier and stiffer string. Conversely, as the speed increases, the fusion coating formation on the surface becomes more difficult to achieve. For these reasons, it is preferable that the speed is generally 15 to 75 m/min although it varies depending on the heating temperature.

As the porosity of the artificial rush grass decreases, the artificial rush grass becomes heavier and stiffer as well as inferior in cushioning and heat-insulating properties, impact resistance, etc. Conversely, as the porosity of the artificial rush grass increases, mechanical strength declines. For these reasons, it is preferable that the porosity is 15 to 50%.

In the artificial rush grass produced by the said method, the tape-like strands made by uniaxial stretching are partially fusion bonded, and fusion coating is formed on the surface of the artificial rush grass straw. Therefore, the artificial rush grass is highly porous, lightweight and excellent in heat-insulating property, cushioning property, impact resistance, mechanical strength, hygiene, weather resistance, etc.

The diameter of the weft yarns is selected considering that the weft yarns are used in the weft of the tatami cover. Therefore, the diameter of the weft yarns is 0.5 to 2 mm, and more preferably 0.8 to 1.5 mm. The weight of each weft yarn is 3000 to 10000 denier, and more preferably 4000 to 6000 denier.

The color of the weft yarns can be selected as appropriate. Examples of the color include red, vermilion, pink, purple, deep blue, ultramarine, blue, indigo blue, green, deep green, light green, brown, ocher, yellow, beige, cream, black, gray, white, and the like.

The warp yarns may be any yarns that are conventionally used in the warp for the production of tatami covers. Examples of the warp yarns include hemp yarns, cotton yarns, polyester yarns, yarns made of a mixture of cotton and polyester, and other types of yarns. The warp yarns are preferably colored red, blue, green, brown, or the like with a colorant or the like.

The anisotropic tatami cover of the present invention is a tatami cover that is woven in such a manner that the warp yarns are exposed on the surface. In this view, it is preferable that the anisotropic tatami cover is woven in a plain or twill weave pattern. To achieve high mechanical strength, it is preferable that the weft yarns adjacently arranged are in close contact with each other and that the warp yarns adjacent to each other are arranged at an interval of 3 to 30 mm as with conventional tatami covers.

The weft yarns of a single color may be used, and also the weft yarns of two or more different colors may be used in combination. Similarly, the warp yarns of a single color may be used, and also the warp yarns of two or more different colors may be used in combination.

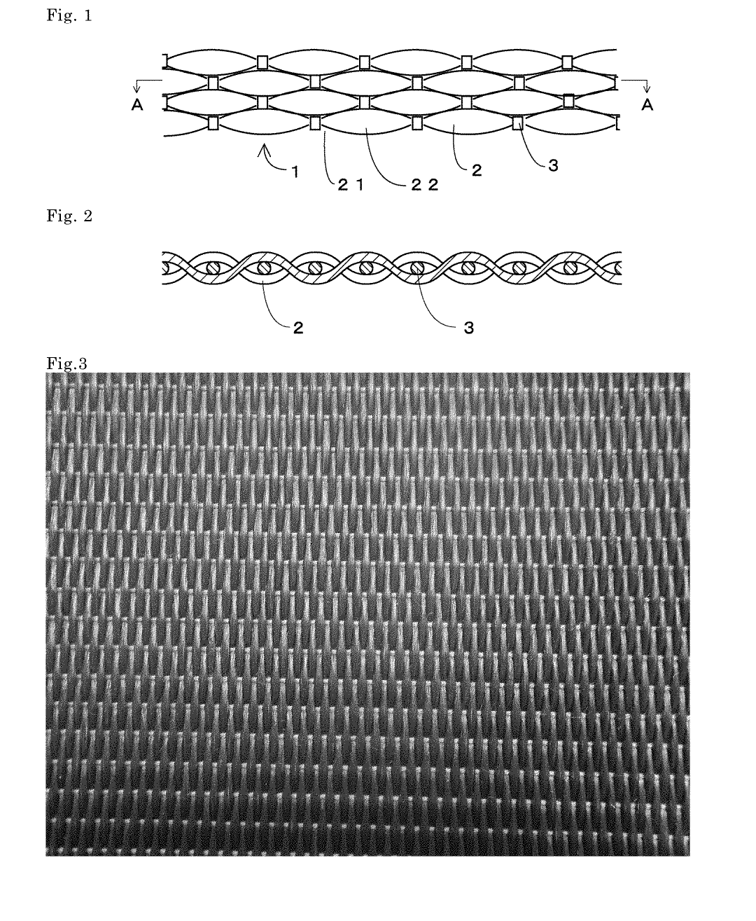

Next, the anisotropic tatami cover of the present invention will be described with reference to drawings. FIG. 1 is a plan view of an example of the anisotropic tatami cover of the present invention, and FIG. 2 is an A-A sectional view of FIG. 1. An anisotropic tatami cover 1 is woven in a plain weave pattern, and is made by interlacing weft yarns 2, 2, . . . with warp yarns 3, 3, . . . one-by-one. At the points where the weft yarns 2 are located under the warp yarns 3, the weft yarns 2 are compacted and smaller in width as viewed from above. The parts of the weft yarns 2 at these points are designated as narrow parts 21. The parts of the weft yarns 2 between the narrow parts 21 are designated as bulging parts 22. Therefore, in the weft yarns 2, the narrow parts 21 and the bulging parts 22 are alternately arranged in the direction of the warp yarns 3. The warp yarns 3 pass over the weft yarns 2 in the narrow parts 21 and pass under the weft yarns 2 in the bulging parts 22. As a result, the warp yarns 3 are exposed on the surface of the tatami cover in the narrow parts 21.

To achieve the anisotropy in the anisotropic tatami cover of the present invention, in which both the weft yarns 2 and the warp yarns 3 are exposed on the surface, the color difference ΔE between the weft yarn 2 and the warp yarn 3 is required to be 6.0 or more, and is preferably 13.0 or more.

The color difference is the distance perceived between two colors or a quantified value of the distance. In the present specification, the color difference is calculated by a color-difference formula based on the colors measured by spectrophotometry using a color difference meter according to JIS Z 8722.

Hereinafter, the details will be described. For the measurement of the color difference between sample 1 and sample 2, firstly, L₁ (lightness), and a₁ and b₁ (chromaticity) of sample 1 are measured with a color difference meter. Secondly, L₂ (lightness), and a₂ and b₂ (chromaticity) of sample 2 are similarly measured with the color difference meter. Finally, the measured values L₁, a₁, b₁, L₂, a₂ and b₂ are substituted into the formula shown below for calculation. The value of ΔE in the formula represents the color difference.

ΔE=[(L₁−L₂)²+(a₁−a₂)²+(b₁−b₂)²]^{1/2}

The warp yarns 3 are exposed on the surface of the tatami cover in the narrow parts 21, which are positioned at a lower level than the bulging parts 22. In this structure, as the diameter of the warp yarns 3 decreases, the warp yarns 3 become more hidden behind the weft yarns 2 and less visible from certain angles. Thus, anisotropy is enhanced. Therefore, the thickness of the warp yarns 3 is preferably smaller than the diameter of the weft yarns 2. More preferably, the thickness of the warp yarns 3 is 2 to 80% of the diameter of the weft yarns. Still more preferably, the thickness of the warp yarns 3 is 5 to 50% of the diameter of the weft yarns.

To achieve high mechanical strength, the anisotropic tatami cover of the present invention is preferably configured such that the weft yarns 2,2 adjacently arranged are in close contact with each other and that the warp yarns 3,3 adjacent to each other are arranged at an interval of 5 to 30 mm as with conventional tatami covers.

To the underside of the anisotropic tatami cover of the present invention, a backing sheet may be bonded. The backing sheet serves to reinforce the anisotropic tatami cover, to prevent the rush grass straws in the anisotropic tatami cover from moving upon the application of a load on the surface of the rush grass, and to prevent the rush grass straws at the edges from fraying.

Examples of the backing sheet include papers; non-woven or woven fabrics made of fibers such as a hemp fiber, a cotton fiber, a polyethylene fiber, a polypropylene fiber, a urethane fiber, a polyacrylic fiber, a polyester fiber, and the like; and resin sheets and resin foam sheets made of a polystyrene resin, a polyvinyl chloride resin, an olefin-type resin (such as a polyethylene resin and a polypropylene resin), a polyurethane resin, a rubber, or the like.

Among these, the synthetic resin sheets are preferred because of their water impermeability, which helps to prevent spilt water on the anisotropic tatami cover from penetrating through to the underside (or a tatami base in the case where the tatami cover is layered on top of the tatami base to form a tatami mat). Particularly preferred are a polyvinyl chloride resin sheet, a polyethylene resin sheet and a polypropylene resin sheet because they are excellent in mechanical strength, weather resistance, flexibility, etc.

Other sheets, such as an oriented sheet made by stretching a sheet containing an olefin-type resin and an inorganic filler and a resin sheet containing any of the said thermoplastic resin blended with a moisture permeable resin, are preferably used because they are water impermeable and air permeable.

Examples of the olefin-type resin include a high-density polyethylene resin, a medium-density polyethylene resin, a low-density polyethylene resin, a linear low-density polyethylene resin, a polypropylene resin, an ethylene-propylene copolymer, an ethylene-1-butene copolymer, an ethylene-1-pentene copolymer, an ethylene-1-hexene copolymer, and the like.

Examples of the inorganic filler include calcium carbonate, magnesium carbonate, aluminum oxide, magnesium oxide, titanium oxide, magnesium hydroxide, talc, mica, clay, and the like.

In the case where an olefin-type resin sheet containing an inorganic filler is stretched, the inorganic filler serves as a core for pore formation in the sheet, thus providing air permeability to the sheet. However, in the case where the inorganic filler content is excessively high, mechanical strength is reduced and water permeability is undesirably imparted. For these reasons, it is generally preferable that the inorganic filler content is 5 to 20 parts by weight relative to 100 parts by weight of the olefin-type resin.

The method for stretching the sheet containing an olefin-type resin and an inorganic filler may be uniaxial stretching or biaxial stretching. The stretching ratio is generally 2 to 10. Regarding the stretching temperature, excessively low temperature makes it impossible to achieve uniform stretching, and excessively high temperature causes the olefin-type resin sheet to become melt and broken. For these reasons, the stretching temperature is preferably in the range of “a 60° C. lower temperature than the melting point of the olefin-type resin in the olefin-type resin sheet” to “the melting point of the olefin-type resin”, and more preferably in the range of “a 50° C. lower temperature than the melting point of the olefin-type resin” to “a 5° C. lower temperature than the melting point of the olefin-type resin”.

The moisture permeable resin is not particularly limited, and any conventionally known moisture permeable resin, for example, polyester-type elastomers, may be used. The moisture permeable resin is preferably highly compatible with the resin used as a main material. In the case where a moisture permeable polyester-type elastomer resin is used, the polyester-type elastomer resin content is generally preferably 0.3 to 20 parts by weight, and more preferably 0.5 to 10 parts by weight relative to 100 parts by weight of the olefin-type resin.

The resin foam sheets are also preferable because, even if dented under load, they will easily return to their original shapes. Particularly preferred are closed-cell polyethylene resin foam sheets having an expansion ratio of 10 to 50, preferably 20 to 40 because they are excellent in flexibility, cushioning property, resilience, etc. and are also water impermeable.

The closed-cell resin foam sheet is a resin foam sheet in which the cells are not in communication with the outside of the sheet. As the volume percentage of closed cells decreases, heat-insulating property, resilience, elasticity, mechanical strength, etc. decline. For this reason, it is preferable that the volume percentage of closed cells is 30% or more, and more preferably 50% or more. The volume percentage of closed cells can easily be measured by, for example, immersing a resin foam sheet in water and measuring an increase in volume as a result of water absorption.

The thickness of the backing sheet is not particularly limited. In general, thinner backing sheets have lower mechanical strength and lower reinforcing effect and are less effective to prevent the rush grass straws from moving, while thicker backing sheets are heavier, less flexible and more difficult to fold. For these reasons, the thickness of the backing sheet is preferably 0.005 to 5 mm, and more preferably 0.01 to 2 mm.

In the case where the backing sheet is bonded to the underside of the anisotropic tatami cover, it is preferable that the backing sheet is firmly bonded to the entire underside surface of the anisotropic tatami cover, including the edges thereof. However, the backing sheet may not be bonded to some areas in the center (not the edges) of the anisotropic tatami cover as long as the unbonded areas are approximately in the form of dots or thin lines.

The method for bonding of the backing sheet maybe any known method for bonding. For example, the backing sheet can be bonded by using an adhesive or pressure-sensitive adhesive based on rubber, acrylic, urethane, silicone, or the like; by using a double-sided pressure-sensitive adhesive sheet; by using a hot-melt adhesive based on polyolefin-type resins such as an ethylene-vinylacetate copolymer and a linear low-density polyethylene resin; or by welding.

The anisotropic tatami cover to which the backing sheet is bonded, is water impermeable and therefore is washable with cold water. In addition, the anisotropic tatami cover is lightweight and less likely to dent, and particularly in the case where the backing sheet is a resin foam sheet, the anisotropic tatami cover is highly cushioned. Therefore, the anisotropic tatami cover can be used as a rush mat in either indoor or outdoor situations, and is also suitable for use as a cushion sheet in places where a load is constantly applied, for example, in places where a wardrobe, a desk, a chair, or the like is placed.

The anisotropic tatami cover of the present invention is suitable for covering a tatami base to make a tatami mat. The tatami base is not particularly limited, and examples include a rice straw tatami base, an artificial tatami base having a core material, and other tatami bases. Rice straw tatami bases are used to make thick tatami mats, and artificial tatami bases having a core material are used to make thin or thick tatami mats.

Rice straw tatami bases are excellent in durability, flexibility, heat insulation, heat retention and moisture-absorption and release. The rice straw tatami base used in the present invention is, for example, a tatami base of about 55 mm in thickness for thick tatami mats, which is conventionally and widely used. More specifically, for example, a tatami base of about 50 mm in thickness, which is made by compressing flat layers of rice straw of about 400 mm in thickness, can be used.

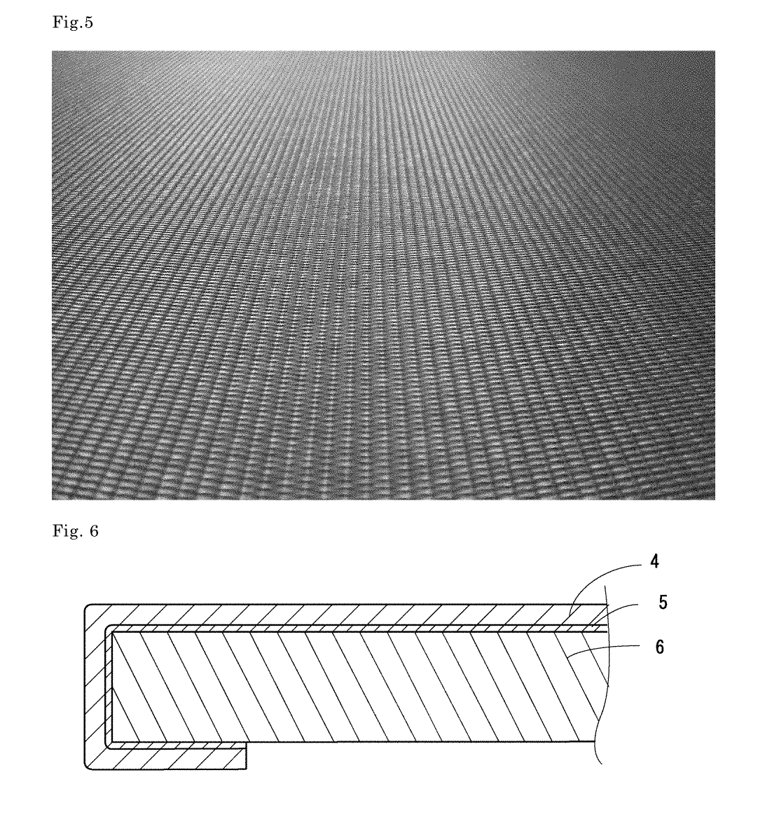

FIG. 6 is a cross-sectional view of an example of a thick tatami mat. In the figure, the numeral 4 represents an anisotropic tatami cover, and a backing sheet 5 is bonded to the underside of the anisotropic tatami cover 4. The anisotropic tatami cover 4 is layered on a rice straw tatami base 6 in such a manner that the backing sheet 5 is in contact with the rice straw tatami base 6. The edges of the anisotropic tatami cover 4 are tucked in under the edges of the rice straw tatami base 6 and fixed to the tatami base 6 by stitching. The thick tatami mat is configured in this manner.

The artificial tatami base having a core material used in the present invention is a tatami base of about 7 to 55 mm in thickness for thin or thick tatami mats, and is generally composed of a core material and a cushion sheet.

The core material serves to provide mechanical strength to tatami mats. Examples of the core material include materials conventionally used as a core material of tatami mats, more specifically, wood fiberboards, closed-cell synthetic resin foamboards, and the like.

The wood fiberboard is a building material which is made by pulping wood or other plant fibers, binding the pulp fibers together with a binder resin and heat-pressing the mixture into a board. Examples of the wood fiberboard include particle boards, plywoods, insulation fiberboards (insulation boards), medium-density fiberboards (MDFs), hard fiberboards (hardboards), and the like.

The closed-cell synthetic resin foamboard is made from, for example, polystyrene, polyethylene, polypropylene or other synthetic resins, and has an expansion ratio of 5 to 30.

Thin tatami mats generally have a total thickness of only 8 to 35 mm. Therefore, as the core material used for thin tatami mats, preferred are wood fiberboards due to their high mechanical strength, and more preferred are medium-density fiberboards (MDFs). The thickness of such boards is preferably 3 to 7 mm, and more preferably 3.5 to 4.5 mm.

The cushion sheet is layered on the surface (tatami cover side) of the core material and serves to provide cushioning property and sound insulating property to thin tatami mats. Examples of the cushion sheet include non-woven or woven fabrics, mats and felts made of fibers such as a hemp fiber, a cotton fiber, a polyethylene fiber, a polypropylene fiber, a urethane fiber, a polyacrylic fiber, a polyester fiber, and the like; foam sheets such as a polystyrene resin foam sheet, a polyethylene resin foam sheet, a polypropylene resin foam sheet, a urethane foam sheet, a rubber foam sheet, and the like; kraft papers; paperboards; cardboards; corrugated papers; and the like.

The basis weight of the cushion sheet is generally 100 to 700 g/m², and the thickness of the cushion sheet is 3 to 6 mm. The cushion sheet may be composed of two or more layers of thin cushion sheets. The cushion sheet maybe layered on both sides of the core material.

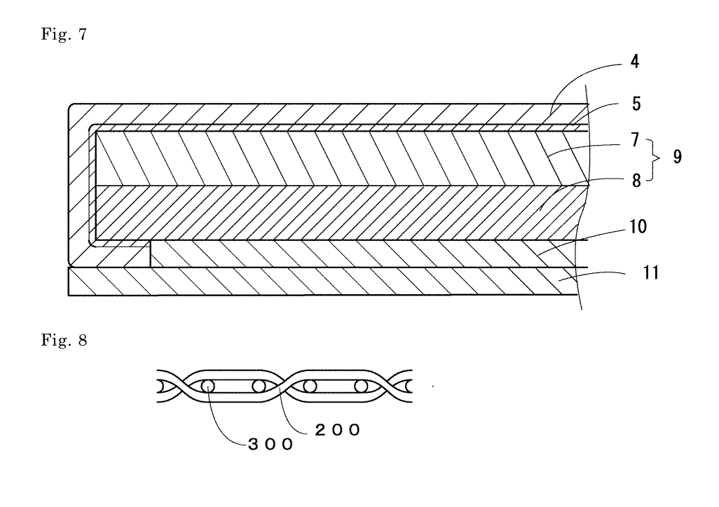

FIG. 7 is a cross-sectional view of an example of a thin tatami mat. In the figure, the numeral 4 represents an anisotropic tatami cover, and a backing sheet 5 is bonded to the underside of the anisotropic tatami cover 4. The numeral 9 represents an artificial tatami base, and a cushion sheet 7 is layered on one side of a core material 8. The anisotropic tatami cover 4 is layered on the artificial tatami base 9 in such a manner that the backing sheet 5 is in contact with the cushion sheet 7. Further, a level difference adjustment sheet 10 and an underside cushion sheet 11 are layered on the opposite side of the core material 8. The edges of the anisotropic tatami cover 4 are folded down along the sides of the artificial tatami base 9 (composed of the core material 8 and the cushion sheet 7) and tucked in between the core material 8 and the underside cushion sheet 11. The level difference adjustment sheet 10 is layered on the core material 8 to fit in the space surrounded by the core material 8, the anisotropic tatami cover 4 and the underside cushion sheet 11. The anisotropic tatami cover 4 and the underside cushion sheet 11 are bonded to each other. The thin tatami mat is configured in this manner.

Examples of the level difference adjustment sheet 10 include non-woven or woven fabrics, mats and felts made of fibers such as a hemp fiber, a cotton fiber, a polyethylene fiber, a polypropylene fiber, a urethane fiber, a polyacrylic fiber, a polyester fiber, and the like; foam sheets such as a polystyrene resin foam sheet, a polyethylene resin foam sheet, a polypropylene resin foam sheet, a urethane foam sheet, a rubber foam sheet, and the like; kraft papers; paperboards; cardboards; corrugated papers; chip boards; and the like.

The underside cushion sheet 11 is layered on the underside of the core material (the bottom side of the thin tatami mat) and serves to provide cushioning property and sound insulating property to the thin tatami mat. Examples of the underside cushion sheet include non-woven or woven fabrics, mats and felts made of fibers such as a hemp fiber, a cotton fiber, a polyethylene fiber, a polypropylene fiber, a urethane fiber, a polyacrylic fiber, a polyester fiber, and the like; foam sheets such as a polystyrene resin foam sheet, a polyethylene resin foam sheet, a polypropylene resin foam sheet, a urethane foam sheet, a rubber foam sheet, and the like; kraft papers; paperboards; cardboards; corrugated papers; and the like.

On the underside of the thin tatami mat, an antislip sheet made of a silicone resin, an acrylic resin, an acrylic silicone resin, or the like; an underside finish sheet such as a cloth pressure-sensitive adhesive tape; and/or the like may be further layered.

Since the anisotropic tatami cover of such a tatami mat is provided with water impermeability by the bonding of the backing sheet, the tatami mat is washable with cold water on the anisotropic tatami cover side, and in the case of a thin tatami mat, even the whole of the tatami mat is washable with cold water. Moreover, the tatami mat is less likely to dent (have unevenness) and is therefore suitable for use in places where a load is constantly applied, for example, in places where a wardrobe, a desk, a chair, or the like is placed.

### EXAMPLES

Next, examples of the present invention will be described, but the present invention is not limited thereto.

### Example 1

A resin composition consisting of 100 parts by weight of a polypropylene resin (manufactured by Japan Polypropylene Corporation, trade name: “NOVATEC-PP” series, MFR: 5.0 g/10 min, density: 0.9 g/cm³, melting point: 155 to 165° C.), 27 parts by weight of calcium carbonate (manufactured by TAKEHARA KAGAKU KOGYO CO., LTD., trade name: “MAX” series) and 2.0 parts by weight of an inorganic azo pigment (manufactured by TOYO INK CO., LTD., trade name: “PPM0866”) was fed into a single-screw kneading extruder with a screw having a diameter of 70 mm, and kneaded and extruded at 210° C. to give a polypropylene resin film having a thickness of 100 μm.

The obtained polypropylene resin film was fed into a uniaxial stretching machine using a heat plate set at 120° C. and stretched at a stretching ratio of 5, and the stretched film was made into tape-like strands having a thickness of 20 μm. The obtained tape-like strands were folded along the uniaxial stretching direction and then passed through a through-hole of 2.0 mm in diameter to form a string-like bundle of the tape-like strands. The string-like bundle was fed into a heating member having a hole with a circular cross-section of 1.0 mm in diameter and passed through the hole at a speed of 65 m/min to give an artificial rush grass straw.

The temperature of the heating member was 300° C. and the heating member had eight pointed projections of 0.05 mm in height circumferentially arranged on the surface in the vicinity of the exit end of the hole at intervals of 45 degrees. In the obtained artificial rush grass straw, the tape-like strands were partially fusion bonded, and fusion coating was formed on the surface of the artificial rush grass straw. Pores and corrugations (bumps and grooves) were randomly formed on the fusion coating. The artificial rush grass straw was black in color, and had a diameter of about 1.1 mm, a porosity of 33% and a weight of 4700 denier. The lightness and chromaticity as measured with a color difference meter (manufactured by Konica Minolta, Inc., “GR-410”) were as follows: L=44.22, a=46.53 and b=23.43.

The artificial rush grass straw was used as a weft yarn and a red polyester yarn of 0.5 mm in diameter was used as a warp yarn to weave an anisotropic tatami cover having a thickness of about 2 mm in a plain weave pattern as illustrated in FIG. 1 and FIG. 2. The intervals of warp yarns were 4 mm and the number of weft shots was 90 picks per 10 cm.

The lightness and chromaticity of the red warp yarn as measured with a color difference meter (manufactured by Konica Minolta, Inc., “GR-410”) were as follows: L=25.97, a=0.84 and b=−0.22. From these values, the color difference ΔE between the warp yarn and the weft yarn was calculated. As a result, the color difference ΔE was 54.5.

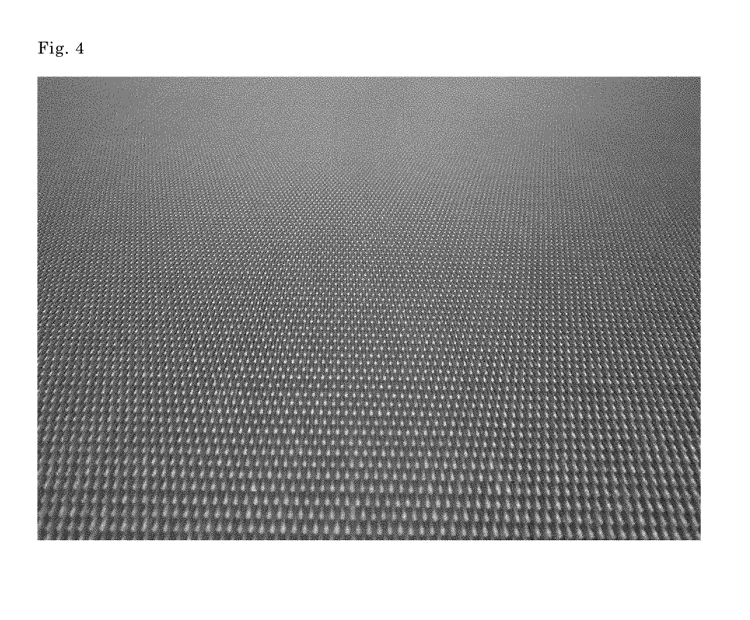

A plan-view photograph of the obtained anisotropic tatami cover is shown in FIG. 3. A photograph of the anisotropic tatami cover viewed from the height at an angle of 30 degrees above horizontal along the direction parallel to the weft yarns is shown in FIG. 4. A photograph of the anisotropic tatami cover viewed from the height at an angle of 30 degrees above horizontal along the direction parallel to the warp yarns is shown in FIG. 5. The comparison among FIGS. 3 to 5 revealed clear differences in designs shown in the plan-view photograph, the photograph viewed from the height at an angle of 30 degrees above horizontal along the direction parallel to the weft yarns, and the photograph viewed from the height at an angle of 30 degrees above horizontal along the direction parallel to the warp yarns.

On the anisotropic tatami cover, an ethylene-vinylacetate copolymer sheet (hot-melt adhesive sheet) which had a thickness of 60 μm and had the same shape and size as those of the anisotropic tatami cover and a polypropylene resin sheet (backing sheet) having a thickness of 100 μm were layered, and then the anisotropic tatami cover and the sheets were bonded together by heat and pressure. Even when a load was applied vertically to the artificial rush grass straws of the anisotropic tatami cover to which the polypropylene resin sheet (backing sheet) was bonded, the artificial rush grass straws did not move. Further, the artificial rush grass straws at the edges of the anisotropic tatami cover did not fray.

As shown in FIG. 6, the anisotropic tatami cover 4 was layered on a rice straw tatami base 6 having a thickness of about 55 mm in such a manner that the polypropylene resin sheet (backing sheet) 5 was in contact with the rice straw tatami base 6. The edges of the anisotropic tatami cover 4 were tucked into under the edges of the rice straw tatami base 6 and then fixed to the tatami base 6 by stitching. Thus, a thick tatami mat was obtained. In FIG. 6, the orientation of the artificial rush grass straws is perpendicular to the plane of the figure.

The obtained thick tatami mat was good in texture, flexibility and cushioning property. Even when the thick tatami mat was tramped, the artificial rush grass straws did not move. In addition, when the thick tatami mat was strongly pressed with a thin stick, it became dented, but shortly after the stick was removed, the thick tatami mat returned to its original shape. Furthermore, when the edges of the anisotropic tatami cover were tucked into under the edges of the rice straw tatami base and then fixed to the tatami base by stitching, the artificial rush grass straws did not fray or move.

### Example 2

A resin composition consisting of 100 parts by weight of a polypropylene resin (manufactured by Japan Polypropylene Corporation, trade name: “NOVATEC-PP” series, MFR: 5.0 g/10 min, density: 0.9 g/cm³, melting point: 155 to 165° C.), 27 parts by weight of calcium carbonate (manufactured by TAKEHARA KAGAKU KOGYO CO., LTD., trade name: “MAX” series) and 2.2 parts by weight of an inorganic azo pigment (manufactured by TOYO INK CO., LTD., trade name: “PPM54700”) was fed into a single-screw kneading extruder with a screw having a diameter of 70 mm, and kneaded and extruded at 210° C. to give a polypropylene resin film having a thickness of 100 μm.

The obtained polypropylene resin film was subjected to stretching, forming and heating in the same manner as in Example 1 to give a green artificial rush grass straw. The obtained artificial rush grass straw had a diameter of about 1.1 mm, a porosity of 33% and a weight of 4700 denier.

A resin composition consisting of 100 parts by weight of a polypropylene resin (manufactured by Japan Polypropylene Corporation, trade name: “NOVATEC-PP” series, MFR: 5.0 g/10 min, density: 0.9 g/cm³, melting point: 155 to 165° C.), 27 parts by weight of calcium carbonate (manufactured by TAKEHARA KAGAKU KOGYO CO., LTD., trade name: “MAX” series) and 2.2 parts by weight of an inorganic azo pigment (manufactured by TOYO INK CO., LTD., trade name: “PPM8YA094VLT”) was fed into a single-screw kneading extruder with a screw having a diameter of 70 mm, and kneaded and extruded at 210° C. to give a polypropylene resin film having a thickness of 100 μm.

The obtained polypropylene resin film was subjected to stretching, forming and heating in the same manner as in Example 1 to give a purple artificial rush grass straw. The obtained artificial rush grass straw had a diameter of about 1.1 mm, a porosity of 33% and a weight of 4700 denier.

These green and purple artificial rush grass straws were alternately used as weft yarns and a red polyester yarn of 0.5 mm in diameter was used as a warp yarn to weave an anisotropic tatami cover having a thickness of about 2 mm in a plain weave pattern as illustrated in FIG. 1 and FIG. 2. The intervals of warp yarns were 4 mm and the number of weft shots was 90 picks per 10 cm. As measured with a color difference meter (manufactured by Konica Minolta, Inc., “GR-410”), the color difference ΔE between the green artificial rush grass straw and the warp yarn was 54.7, and the color difference ΔE between the purple artificial rush grass straw and the warp yarn was 51.0.

On a closed-cell polyethylene resin foam sheet (backing sheet) having a thickness of 1 mm, which had the same shape as that of the obtained anisotropic tatami cover but was a little larger-sized, an acrylic pressure-sensitive adhesive was applied and dried to form a pressure-sensitive adhesive layer. The anisotropic tatami cover was layered on the pressure-sensitive adhesive layer and pressure-bonded to give a layered tatami cover having a thickness of about 3.0 mm. Even when a load was applied vertically to the artificial rush grass straws of the layered tatami cover, the artificial rush grass straws did not move. Further, the artificial rush grass straws at the edges of the layered tatami cover did not fray.

As shown in FIG. 7, on one surface of a core material 8 which made of a medium-density fiberboard (MDF) and had a thickness of 4 mm, a density of 0.48 g/cm³ and a flexural strength of 9 N/mm, a pile of two sheets of polyester fiber non-woven fabrics each having a thickness of 2 mm and a basis weight of 200 mg/m² was layered as a cushion sheet 7 having a thickness of 4.0 mm. On top of that, the anisotropic tatami cover 4 having a thickness of about 3.0 mm was layered in such a manner that the closed-cell polyethylene resin foam sheet (backing sheet) 5 was in contact with the cushion sheet 7. The edges of the anisotropic tatami cover 4 were folded down along the sides of the artificial tatami base 9 composed of the core material 8 and the cushion sheet 7, tucked into under the core material 8, and then heat-bonded thereto by heat and pressure with a high-frequency welder.

Next, on the part of the underside surface of the core material 8 where the anisotropic tatami cover 4 was not present, a level difference adjustment sheet 10 made of a polyester fiber non-woven fabric having a thickness of 2 mm and a basis weight of 200 g/m² was layered. On the whole underside of the layered body, an underside cushion sheet 11 made of a polyester fiber non-woven fabric having a thickness of 2 mm and a basis weight of 200 g/m² was layered, and then the edges of the underside cushion sheet 11 were heat-bonded thereto by heat and pressure with a high-frequency welder. Thus, a thin tatami mat having a thickness of 15.0 mm was obtained.

The obtained thin tatami mat was good in texture, flexibility and cushioning property. Even when the thin tatami mat was tramped, the artificial rush grass straws did not move. In addition, when the thin tatami mat was strongly pressed with a thin stick, it became dented, but shortly after the stick was removed, the thin tatami mat returned to its original shape. Furthermore, when the edges of the layered tatami cover were tucked into under the edges of the base composed of the core material and the cushion sheet and then heat-bonded, the artificial rush grass straws did not fray or move.

### Example 3

Variously colored polypropylene resin films having a thickness of 100 μm were obtained in the same manner as in Example 1 except that 1.0 to 2.5 parts by weight of various inorganic pigments (manufactured by TOYO INK CO., LTD., trade name: “PPM” series) were used instead of 2.0 parts by weight of the inorganic azo pigment (manufactured by TOYO INK CO., LTD., trade name: “PPM 0866 ”).

The variously colored polypropylene resin films were subjected to stretching, forming and heating in the same manner as in Example 1 to give the corresponding colored artificial rush grass straws. The obtained artificial rush grass straws had a diameter of about 1.1 mm, a porosity of 33% and a weight of 4700 denier. The L, a and b values of the artificial rush grass straws were measured with a color difference meter (manufactured by Konica Minolta, Inc., “GR-410”). These values are shown in combination with the corresponding color in Table 1.

One of the obtained artificial rush grass straws was used as a weft yarn and a polyester yarn of 0.5 mm in diameter having one of the colors indicated in Table 2 was used as a warp yarn to weave an anisotropic tatami cover having a thickness of about 2 mm in a plain weave pattern as illustrated in FIG. 1 and FIG. 2. The intervals of warp yarns were 4 mm and the number of weft shots was 90 picks per 10 cm. The L, a and b values of each of the colored polyester yarns (warp yarns) were measured with a color difference meter (manufactured by Konica Minolta, Inc., “GR-410”). These values are shown in Table 2. The color difference ΔE between the weft yarn (artificial rush grass) and the warp yarn of the obtained anisotropic tatami cover was calculated. The results are shown in Table 3.

TABLE 1

| | Color | L | a | b |
|---|---|---|---|---|
| Weft (artificial | Black | 25.97 | 0.84 | −0.22 |
| rush grass) | Green | 61.20 | −4.37 | 12.65 |
| | Blue violet | 40.88 | 3.30 | −3.51 |
| | Leaf green | 68.04 | −2.18 | 15.36 |
| | Ivory | 79.40 | 2.43 | 18.76 |
| | Mocha beige | 61.23 | 2.95 | 12.78 |
| | Pink | 64.54 | 5.71 | 9.27 |

TABLE 2

| | Color | L | a | b |
|---|---|---|---|---|
| Polyester | Red | 44.22 | 46.53 | 23.43 |
| yarn (warp) | Light blue | 56.2 | −4.31 | −28.6 |
| | Blue | 22.33 | 10.58 | −39 |
| | Green | 34.63 | −24 | 8.3 |
| | Yellow | 74.5 | 0.99 | 45.41 |
| | Orange | 54.15 | 32.68 | 32.77 |
| | Purple | 21.08 | 22.58 | −17.4 |
| | Vermilion | 33.07 | 53.81 | 16.7 |
| | White | 69.11 | 0.42 | 1.42 |
| | Brown | 36.19 | 12.81 | 18.03 |
| | Black | 13.44 | 1.23 | −0.16 |

TABLE 3

| | | Artificial rush grass (weft) | | | | | | |
|---|---|---|---|---|---|---|---|---|
| | | | | Blue | Leaf | | Mocha | |
| Color difference ΔE | | Black | Green | violet | green | Ivory | beige | Pink |
| Polyester yarn (warp) | Red | 54.6 | 54.7 | 51.0 | 54.8 | 56.6 | 48.0 | 47.7 |
| | Light blue | 41.8 | 41.6 | 30.4 | 45.6 | 53.2 | 42.3 | 40.1 |
| | Blue | 40.1 | 66.3 | 40.7 | 72.1 | 81.6 | 65.2 | 64.3 |
| | Green | 27.6 | 33.3 | 30.4 | 40.5 | 53.0 | 38.1 | 42.2 |
| | Yellow | 66.6 | 35.8 | 59.4 | 30.9 | 27.1 | 35.3 | 37.8 |
| | Orange | 53.8 | 42.7 | 48.5 | 41.4 | 41.8 | 36.5 | 37.3 |
| | Purple | 28.1 | 56.9 | 30.9 | 62.4 | 71.5 | 53.9 | 53.7 |
| | Vermilion | 56.1 | 64.8 | 55.0 | 66.0 | 69.2 | 58.3 | 58.0 |
| | White | 43.2 | 14.5 | 28.8 | 14.2 | 20.3 | 14.1 | 10.5 |
| | Brown | 24.1 | 30.8 | 24.0 | 35.3 | 44.4 | 27.4 | 30.5 |
| | Black | 12.5 | 49.8 | 27.7 | 56.9 | 68.6 | 49.5 | 52.2 |

### INDUSTRIAL APPLICABILITY

The anisotropic tatami cover of the present invention can provide different hues depending on the angle from which it is viewed, and is therefore highly aesthetically valuable. When a tatami mat using this tatami cover as a top layer is laid in a room or the like, the tatami mat provides different hues depending on the angle from which it is viewed in the room or the like, and thus makes the room or the like more decorative. Therefore, such a tatami mat can be widely used in the architecture field.

### REFERENCE SIGNS LIST

1 Artificial Rush Grass
2 Weft Yarn
3 Warp Yarn
4 Anisotropic Tatami Cover
5 Backing Sheet
6 Rice Straw Tatami Base
7 Cushion Sheet
8 Core Material
9 Artificial Tatami Base
10 Level Difference Adjustment Sheet
11 Underside Cushion Sheet

1. An anisotropic tatami cover, which is made of weft yarns made of rush grass or artificial rush grass and warp yarns, the weft yarns having a diameter of 0.5 to 2 mm, the warp yarns having a diameter which is 5 to 80% of the diameter of the weft yarns, and which is woven in such a manner that the warp and weft yarns are exposed on the surface of the anisotropic tatami cover, wherein a color difference ΔE between the weft and warp yarns is 6.0 or more.

2. (canceled)

3. The anisotropic tatami cover according to claim 1, wherein the weft yarns have of one or more colors.

4. The anisotropic tatami cover according to claim 1, wherein the warp yarns are hemp yarns, cotton yarns, polyester yarns or yarns made of a mixture of cotton and polyester.

5. The anisotropic tatami cover according to claim 1, wherein the warp yarns have of one or more colors.

6. The anisotropic tatami cover according to claim 1, wherein the anisotropic tatami cover is woven in a plain or twill weave pattern.

7. The anisotropic tatami cover according to claim 1, wherein the weft yarns adjacently arranged are in close contact with each other and the warp yarns adjacent to each other are arranged at an interval of 5 to 30 mm.

8. The anisotropic tatami cover according to claim 1, wherein the anisotropic tatami cover further has a backing sheet bonded to the underside of the anisotropic tatami cover.
